(19) United States
(12) Patent Application Publication
(10) Pub. No.: US 2023/0325686 A1
(43) Pub. Date: Oct. 12, 2023

(54) SYSTEM AND METHOD FOR PROVIDING GLOBAL COUNTERFACTUAL EXPLANATIONS IN ARTIFICIAL INTELLIGENCE

(71) Applicant: JPMorgan Chase Bank, N.A., New York, NY (US)

(72) Inventors: Saumitra MISHRA, London (GB); Dan LEY, Crediton (GB); Daniele MAGAZZENI, London (GB)

(73) Assignee: JPMorgan Chase Bank, N.A., New York, NY (US)

(21) Appl. No.: 18/126,081

(22) Filed: Mar. 24, 2023

Related U.S. Application Data
(60) Provisional application No. 63/329,004, filed on Apr. 8, 2022.

(51) Int. Cl. G06N 5/022

(52) U.S. Cl. CPC G06N 5/022

(57) ABSTRACT

A method for providing a global counterfactual explanation and a system for implementing the method are disclosed. The method includes generating an initial ground set based on a first candidate set of outer-If conditions, and a second candidate set used for selecting Inner-If or Then conditions. The method then evaluates a fixed number of triples and forms a new ground set that provides a recourse accuracy level above a reference threshold, in which the fixed number of triples included in the new ground set is less than a number of triples included in the initial ground set. The method further includes sorting the new ground set by recourse accuracy, selecting a predetermined number of triples based on corresponding recourse accuracies indicated in the sorting, and performing calculation based on the selected number of triples.

### CROSS-REFERENCE TO RELATED APPLICATIONS

This application claims the benefit of U.S. Provisional Pat. Appl. No. 63/329,004, filed Apr. 8, 2022. The disclosure of each of these documents, including the specification, drawings, and claims, is incorporated herein by reference in its entirety.

### TECHNICAL FIELD

This disclosure generally relates to a system and method for providing global counter factual explanations.

### BACKGROUND

The developments described in this section are known to the inventors. However, unless otherwise indicated, it should not be assumed that any of the developments described in this section qualify as prior art merely by virtue of their inclusion in this section, or that those developments are known to a person of ordinary skill in the art.

Counterfactual explanations (CEs) are a common tool for determining what small changes can be made to the input of a model such that the output changes to the desired prediction. The CEs may be used in settings whereby an end user may, for example, be informed of a slight change in information for rendering a different outcome or result. For example, the CEs may indicate a slight change in the user's loan application (e.g., debt level) may change a rejection decision to an approval.

Although CEs have been applied locally or at an individual level, attempts have been made to apply the CEs globally. In such a setting, global CEs (GCEs) may indicate small changes that can be made to groups of inputs, or subgroups, such that model predictions are flipped for a sufficient proportion with the subgroups. The GCEs may be used to compare recourses between subgroups to assess model fairness. For example, if the global recourses for foreign workers are much more costly than for non-foreign workers, this may suggest some level of model bias.

However, currently available frameworks for providing GCEs perform poorly on datasets with a large proportion of continuous features and is also computationally inefficient, leading to excessive utilization of processor resources. Such deficiencies may pose a problem to (a) practitioners who wish to quickly vet the fairness of their models, and (b) models which incorporate fairness assessment into their training procedures.

### SUMMARY

According to an aspect of the present disclosure, a method for outputting a global counterfactual explanation is provided. The method includes performing, using a processor and a memory: generating an initial ground set based on a first candidate set of outer-If conditions (SD), and a second candidate set used for selecting Inner-If or Then conditions (RL); evaluating a fixed number of triples and forming a new ground set that provides a recourse accuracy level above a reference threshold, in which the fixed number of triples included in the new ground set is less than a number of triples included in the initial ground set; sorting the new ground set by recourse accuracy; selecting a predetermined number of triples based on corresponding recourse accuracies indicated in the sorting; and performing calculation based on the selected number of triples.

According to another aspect of the present disclosure, the generating of the ground set is performed by iterating over the second candidate set in O(n) time and computing feature combinations, before removing any items that contain a feature combination that only occurs once, for yielding a new RL with size an, in which a is greater than or equal to 0 and less than or equal 1.

According to another aspect of the present disclosure, the generating of the ground set is performed by filtering a dataset based on the outer-If or the inner-If conditions, and separately deploying a method for generating Then conditions.

According to yet another aspect of the present disclosure, each triple includes an outer-If condition, an inner-If condition, and a Then condition.

According to another aspect of the present disclosure, the selecting of the predetermined number of triples includes selecting highest-performing triples within the new ground set.

According to a further aspect of the present disclosure, each triple forming the new ground set increases the recourse accuracy level.

According to yet another aspect of the present disclosure, one or more constraints are applied during the generating of the initial ground set.

According to a further aspect of the present disclosure, the initial ground set removes a feature combination that only occurs once.

According to another aspect of the present disclosure, an upper bound defined as acc(R)≤acc(V) is reached before an algorithm for providing the global counterfactual explanation has completed execution, acc(R) is a percentage of instances in X_{aff} that are provided with a successful recourse, X_{aff} is a set of individuals with an unfavorable prediction from a model, and acc(v) is a recourse accuracy.

According to a further aspect of the present disclosure, the algorithm is terminated prior to its completion when the upper bound for saturation is reached.

According to another aspect of the present disclosure, a system for outputting a global counterfactual explanation is disclosed. The system includes at least one processor; at least one memory; and at least one communication circuit. The at least one processor performs: generating an initial ground set based on a first candidate set of outer-If conditions (SD), and a second candidate set used for selecting Inner-If or Then conditions (RL); evaluating a fixed number of triples and forming a new ground set that provides a recourse accuracy level above a reference threshold, in which the fixed number of triples included in the new ground set is less than a number of triples included in the initial ground set; sorting the new ground set by recourse accuracy; selecting a predetermined number of triples based on corresponding recourse accuracies indicated in the sorting; and performing calculation based on the selected number of triples.

According to a further aspect of the present disclosure, the generating of the ground set is performed by iterating over the second candidate set in O(n) time and computing feature combinations, before removing any items that contain a feature combination that only occurs once, for yielding a new RL with size an, in which a is greater than or equal to 0 and less than or equal 1.

According to a further aspect of the present disclosure, the generating of the ground set is performed by filtering a dataset based on the outer-If or the inner-If conditions, and separately deploying a method for generating Then conditions.

According to a further aspect of the present disclosure, each triple includes an outer-If condition, an inner-If condition, and a Then condition.

According to a further aspect of the present disclosure, the selecting of the predetermined number of triples includes selecting highest-performing triples within the new ground set.

According to a further aspect of the present disclosure, each triple forming the new ground set increases the recourse accuracy level.

According to a further aspect of the present disclosure, one or more constraints are applied during the generating of the initial ground set.

According to a further aspect of the present disclosure, the initial ground set removes a feature combination that only occurs once.

According to a further aspect of the present disclosure, an upper bound defined as acc(R)≤acc(V) is reached before an algorithm for providing the global counterfactual explanation has completed execution, acc(R) is a percentage of instances in X_{aff} that are provided with a successful recourse, X_{aff} is a set of individuals with an unfavorable prediction from a model, and acc(v) is a recourse accuracy.

According to a further aspect of the present disclosure, the algorithm is terminated prior to its completion when the upper bound for saturation is reached.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates a computer system for implementing a global counter explanation (GCE) system in accordance with an exemplary embodiment.

FIG. 2 illustrates an exemplary diagram of a network environment with an GCE system in accordance with an exemplary embodiment.

FIG. 3 illustrates a system diagram for implementing a GCE system in accordance with an exemplary embodiment.

FIG. 4A illustrates a workflow for a GCE system in accordance with an exemplary embodiment.

FIG. 4B illustrates a summary of enhancements provided by a GCE system in accordance with an exemplary embodiment.

FIG. 5 illustrates a redundancy in a ground set in accordance with an exemplary embodiment.

FIG. 6 illustrates computational improvements provided by a GCE system in accordance with an exemplary embodiment.

FIG. 7 illustrates an effect of a frequent itemset mining algorithm threshold in a Then Generation method applied by a GCE system in accordance with an exemplary embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

As is traditional in the field of the present disclosure, example embodiments are described, and illustrated in the drawings, in terms of functional blocks, units and/or modules. Those skilled in the art will appreciate that these blocks, units and/or modules are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the blocks, units and/or modules being implemented by microprocessors or similar, they may be programmed using software (e.g., microcode) to perform various functions discussed herein and may optionally be driven by firmware and/or software. Alternatively, each block, unit and/or module may be implemented by dedicated hardware, or as a combination of dedicated hardware to perform some functions and a processor (e.g., one or more programmed microprocessors and associated circuitry) to perform other functions. Also, each block, unit and/or module of the example embodiments may be physically separated into two or more interacting and discrete blocks, units and/or modules without departing from the scope of the inventive concepts. Further, the blocks, units and/or modules of the example embodiments may be physically combined into more complex blocks, units and/or modules without departing from the scope of the present disclosure.

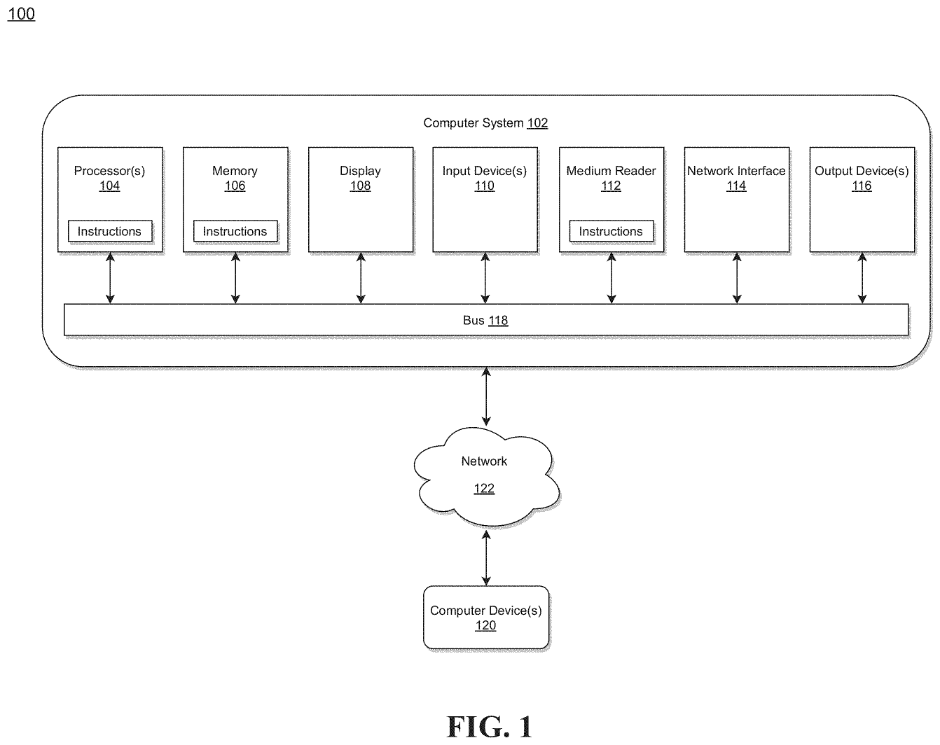

FIG. 1 illustrates a computer system for implementing a global counter explanation (GCE) system in accordance with an exemplary embodiment.

The system 100 is generally shown and may include a computer system 102, which is generally indicated. The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term system shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, blu-ray disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid-state display, a cathode ray tube (CRT), a plasma display, or any other known display.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The network interface 114 may include, without limitation, a communication circuit, a transmitter or a receiver. The output device 116 may be, but is not limited to, a speaker, an audio out, a video out, a remote-control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited thereto, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and an operation mode having parallel processing capabilities. Virtual computer system processing can be constructed to implement one or more of the methods or functionality as described herein, and a processor described herein may be used to support a virtual processing environment.

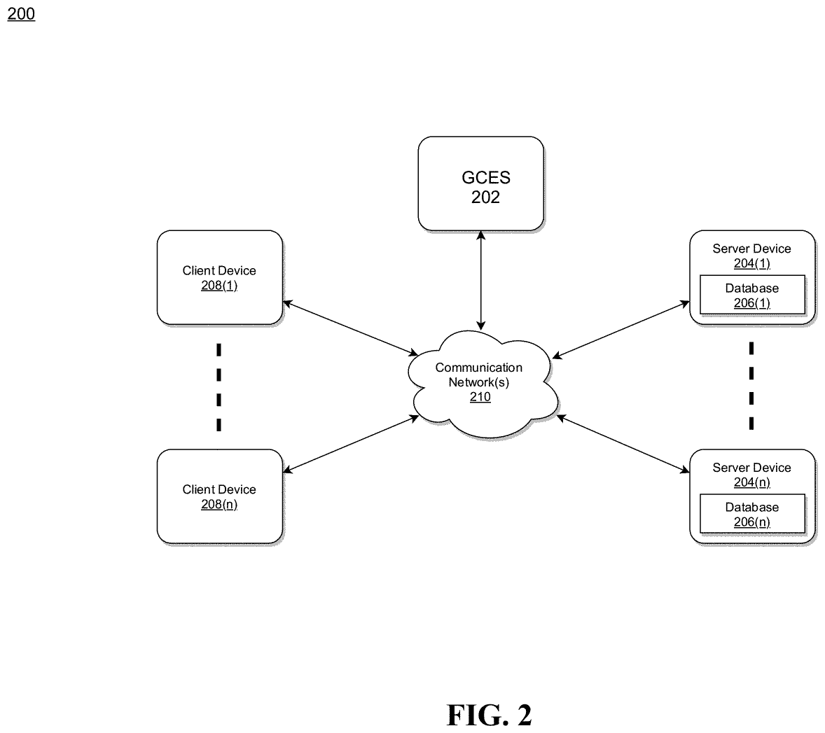

FIG. 2 illustrates an exemplary diagram of a network environment with a GCE system in accordance with an exemplary embodiment.

A GCE system (GCES) 202 may be implemented with one or more computer systems similar to the computer system 102 as described with respect to FIG. 1.

The GCE system 202 may store one or more applications that can include executable instructions that, when executed by the GCE system 202, cause the GCE system 202 to perform actions, such as to execute, transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment or other networking environments. The application(s) may be executed within or as virtual machine(s) or virtual server(s) that may be managed in a cloud-based computing environment. Also, the application(s), and even the GCE system 202 itself, may be located in virtual server(s) running in a cloud-based computing environment rather than being tied to one or more specific physical network computing devices. Also, the application(s) may be running in one or more virtual machines (VMs) executing on the GCE system 202. Additionally, in one or more embodiments of this technology, virtual machine(s) running on the GCE system 202 may be managed or supervised by a hypervisor.

In the network environment 200 of FIG. 2, the GCE system 202 is coupled to a plurality of server devices 204(1)-204(n) that hosts a plurality of databases 206(1)-206(n), and also to a plurality of client devices 208(1)-208(n) via communication network(s) 210. According to exemplary aspects, databases 206(1)-206(n) may be configured to store data that relates to distributed ledgers, blockchains, user account identifiers, biller account identifiers, and payment provider identifiers. A communication interface of the GCE system 202, such as the network interface 114 of the computer system 102 of FIG. 1, operatively couples and communicates between the GCE system 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the GCE system 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The GCE system 202 may be a standalone device or integrated with one or more other devices or apparatuses, such as one or more of the server devices 204(1)-204(n), for example. In one particular example, the GCE system 202 may be hosted by one of the server devices 204(1)-204(n), and other arrangements are also possible. Moreover, one or more of the devices of the GCE system 202 may be in the same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the GCE system 202 via the communication network(s) 210 according to the HTTP-based protocol, for example, although other protocols may also be used. According to a further aspect of the present disclosure, in which the user interface may be a Hypertext Transfer Protocol (HTTP) web interface, but the disclosure is not limited thereto.

The server devices 204(1)-204(n) may be hardware or software or may represent a system with multiple servers in a pool, which may include internal or external networks. The server devices 204(1)-204(n) hosts the databases 206(1)-206(n) that are configured to store metadata sets, data quality rules, and newly generated data.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. Client device in this context refers to any computing device that interfaces to communications network(s) 210 to obtain resources from one or more server devices 204(1)-204(n) or other client devices 208(1)-208(n).

According to exemplary embodiments, the client devices 208(1)-208(n) in this example may include any type of computing device that can facilitate the implementation of the GCE system 202 that may efficiently provide a platform for implementing a cloud native GCE system module, but the disclosure is not limited thereto.

The client devices 208(1)-208(n) may run interface applications, such as standard web browsers or standalone client applications, which may provide an interface to communicate with the GCE system 202 via the communication network(s) 210 in order to communicate user requests. The client devices 208(1)-208(n) may further include, among other features, a display device, such as a display screen or touchscreen, and/or an input device, such as a keyboard, for example.

Although the exemplary network environment 200 with the GCE system 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the GCE system 202, the server devices 204(1)-204(n), or the client devices 208(1)-208(n), for example, may be configured to operate as virtual instances on the same physical machine. For example, one or more of the GCE system 202, the server devices 204(1)-204(n), or the client devices 208(1)-208(n) may operate on the same physical device rather than as separate devices communicating through communication network(s) 210. Additionally, there may be more or fewer GCE system 202, server devices 204(1)-204(n), or client devices 208(1)-208(n) than illustrated in FIG. 2. According to exemplary embodiments, the GCE system 202 may be configured to send code at run-time to remote server devices 204(1)-204(n), but the disclosure is not limited thereto.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

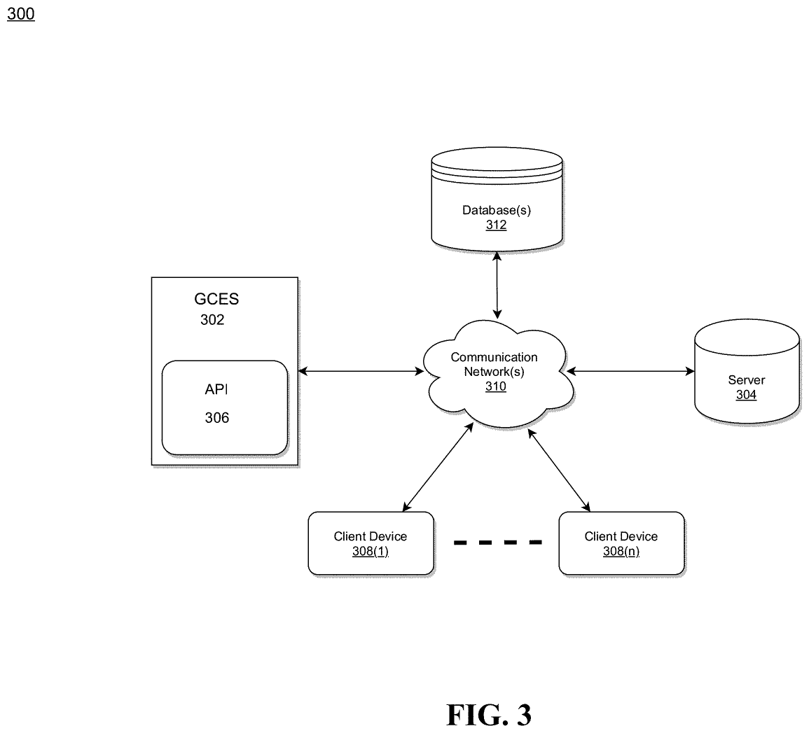

FIG. 3 illustrates a system diagram for implementing a GCE system in accordance with an exemplary embodiment.

As illustrated in FIG. 3, the system 300 may include a GCE system 302 within which a group of API modules 306 is embedded, a server 304, a database(s) 312, a plurality of client devices 308(1) . . . 308(n), and a communication network 310.

According to exemplary embodiments, the GCE system 302 including the API modules 306 may be connected to the server 304, and the database(s) 312 via the communication network 310. Although there is only one database that has been illustrated, the disclosure is not limited thereto. Any number of databases may be utilized. The GCE system 302 may also be connected to the plurality of client devices 308(1) . . . 308(n) via the communication network 310, but the disclosure is not limited thereto.

According to exemplary embodiment, the GCE system 302 is described and shown in FIG. 3 as including the API modules 306, although it may include other rules, policies, modules, databases, or applications, for example. According to exemplary embodiments, the database(s) 312 may be embedded within the GCE system 302. According to exemplary embodiments, the database(s) 312 may be configured to store configuration details data corresponding to a desired data to be fetched from one or more data sources, user information data etc., but the disclosure is not limited thereto.

According to exemplary embodiments, the API modules 306 may be configured to receive real-time feed of data or data at predetermined intervals from the plurality of client devices 308(1) . . . 308(n) via the communication network 310.

The API modules 306 may be configured to implement a user interface (UI) platform that is configured to enable GCE system as a service for a desired data processing scheme. The UI platform may include an input interface layer and an output interface layer. The input interface layer may request preset input fields to be provided by a user in accordance with a selection of an automation template. The UI platform may receive user input, via the input interface layer, of configuration details data corresponding to a desired data to be fetched from one or more data sources. The user may specify, for example, data sources, parameters, destinations, rules, and the like. The UI platform may further fetch the desired data from said one or more data sources based on the configuration details data to be utilized for the desired data processing scheme, automatically implement a transformation algorithm on the desired data corresponding to the configuration details data and the desired data processing scheme to output a transformed data in a predefined format, and transmit, via the output interface layer, the transformed data to downstream applications or systems.

The plurality of client devices 308(1) . . . 308(n) are illustrated as being in communication with the GCE system 302. In this regard, the plurality of client devices 308(1) . . . 308(n) may be “clients” of the GCE system 302 and are described herein as such. Nevertheless, it is to be known and understood that the plurality of client devices 308(1) . . . 308(n) need not necessarily be “clients” of the GCE system 302, or any entity described in association therewith herein. Any additional or alternative relationship may exist between either or both of the plurality of client devices 308(1) . . . 308(n) and the GCE system 302, or no relationship may exist.

The first client device 308(1) may be, for example, a smart phone. Of course, the first client device 308(1) may be any additional device described herein. The second client device 308(n) may be, for example, a personal computer (PC). Of course, the second client device 308(n) may also be any additional device described herein. According to exemplary embodiments, the server 304 may be the same or equivalent to the server device 204 as illustrated in FIG. 2.

The process may be executed via the communication network 310, which may comprise plural networks as described above. For example, in an exemplary embodiment, one or more of the plurality of client devices 308(1) . . . 308(n) may communicate with the GCE system 302 via broadband or cellular communication. Of course, these embodiments are merely exemplary and are not limiting or exhaustive.

The computing device 301 may be the same or similar to any one of the client devices 208(1)-208(n) as described with respect to FIG. 2, including any features or combination of features described with respect thereto. The GCE system 302 may be the same or similar to the GCE system 202 as described with respect to FIG. 2, including any features or combination of features described with respect thereto.

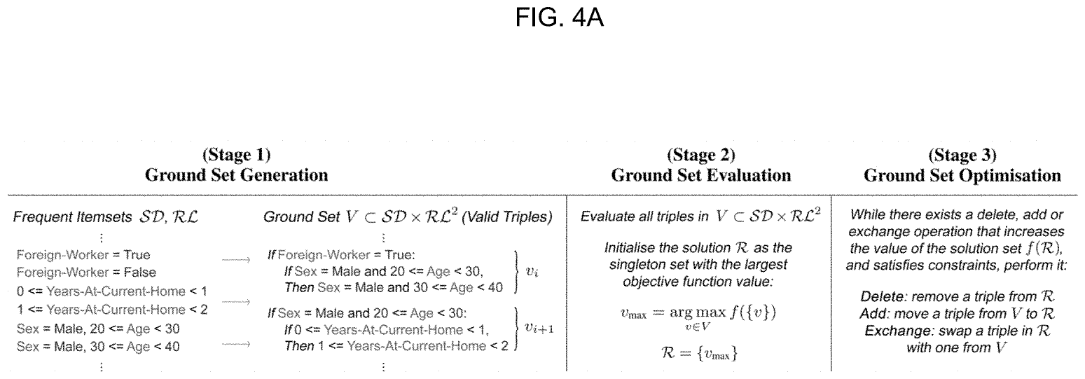

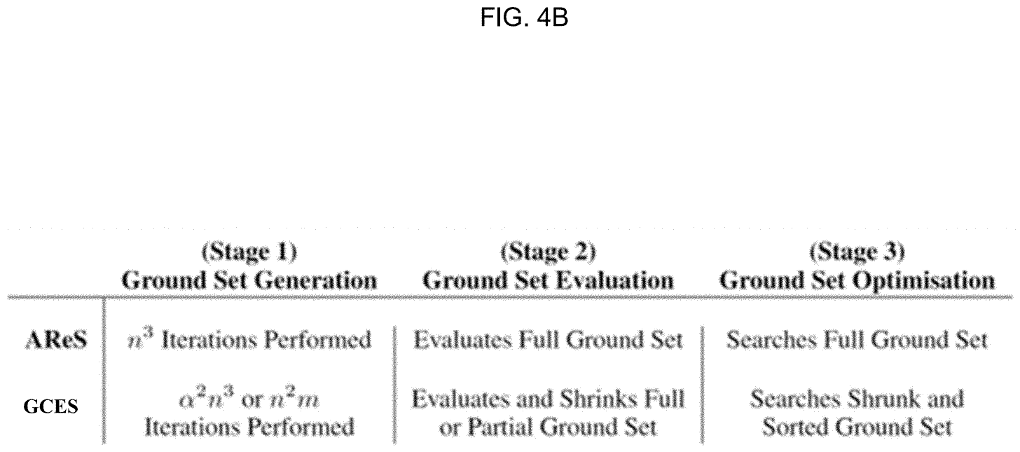

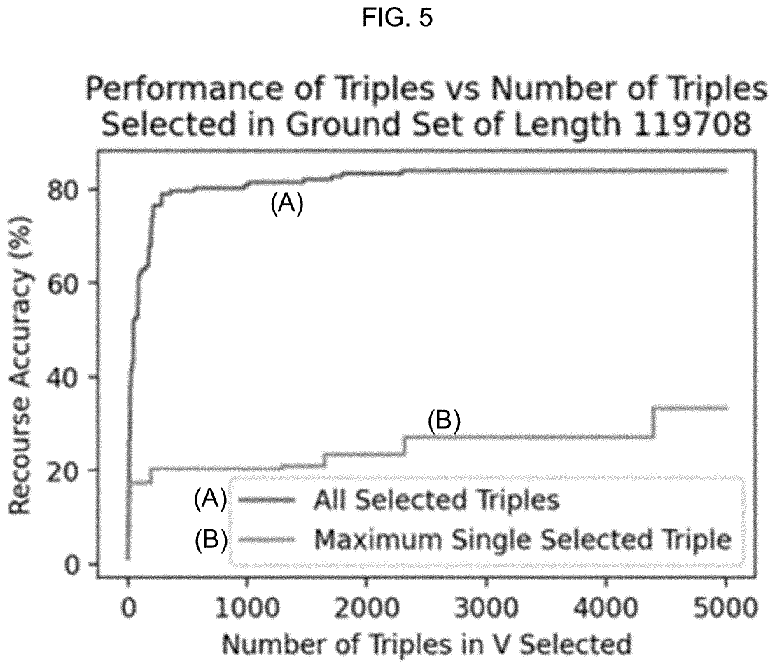

FIG. 4A illustrates a workflow for a GCE system in accordance with an exemplary embodiment. FIG. 4B illustrates a summary of enhancements provided by a GCE system in accordance with an exemplary embodiment. FIG. 5 illustrates a redundancy in a ground set in accordance with an exemplary embodiment.

Local counterfactual explanations have been studied in explainability, with a range of application dependent methods emerging in fairness, recourse and model understanding. However, shortcomings associated with these methods includes their inability to provide explanations beyond the local or instance level. While a notion of a global explanation has been touched upon, typically suggesting aggregating masses of local explanations in the hope of ascertaining global properties, workable frameworks that are reliable and/or computationally tractable were unavailable.

Local counterfactual explanations were defined as points that are close to a query input, with respect to some distance metric, that result in a desired machine learning model prediction. Another approach included proposal of desirable properties of counterfactual explanations and generation of counterfactual explanations that achieved the desirable properties. Other approaches included generation of plausible CEs by consideration of proximity to a data manifold, or taking into account causal relations among input features. Actionability of recourse is another desired data as some features may be non-actionable and hence should not be part of the CEs. In another direction, some approaches focused on generating CEs for specific model categories (e.g., tree-based models, differentiable models).

Counterfactual explanations may identify input perturbations that result in desired predictions from machine learning (ML) models. A key benefit of these explanations is their ability to offer recourse to affected individuals in certain scenarios (e.g., automated credit decisioning). Recent years have witnessed a surge of research therein, with a focus on identifying desirable properties of CEs, developing the methods to model those properties and understanding the weaknesses and vulnerabilities of the proposed methods.

However, the research efforts so far have largely centered around local analysis, generating explanations for individual inputs. Such analysis may help to vet model behavior at an instance-level, though it is seldom obvious if the insights gained therein would generalize globally. For example, a local CE may suggest that a particular decisioning model is not biased against a protected attribute (e.g., gender, race) despite net biases existing across all inputs. A potential way to gain global insights is to aggregate local explanations, but given that the generation of CEs is generally computationally expensive, it is not evident that such an approach would scale well or retain certainly.

Despite a growing desire for global explanation methods that provide summaries of model behavior, struggles associated with summarizing complex high-dimensional models globally has yet to be comprehensively solved. Some manner of aggregations of local explanations have been suggested, although no compelling results have been shown that (a) are computationally tractable, and (b) return reliable GCEs. Although there has been a desire for more interactivity with explanation tools, alongside global summaries, such considerations cannot be accommodated until efficiency issues associated with the existing global methods were addressed.

Although Actionable Recourse Summaries (AReS) was recently proposed as a potential framework for constructing global counterfactual explanations (GCEs), AReS had several shortcomings that limited its application for real-world usage. Specifically, AReS was (a) computationally expensive (i.e., required heavy processing power), and (b) sensitive to continuous features. Accordingly, a modified framework was desired for providing GCEs for real-world implementation possibilities.

According to exemplary aspects, a GCE system with a modified algorithm (different than that is provided in the original AReS framework) is provided for overcoming the above noted limitations in the original AReS framework for significant performance improvements in processor utilization and reliability of data application, inclusive of continuous features.

The GCE system or framework may adopt a model agnostic, interpretable structure, termed two-level recourse set. According to exemplary aspects, the two-level recourse set may contain triples of the form Outer-If/Inner-If/Then conditions, as illustrated in FIG. 4A. As further illustrated in FIG. 4A, a frequent itemset mining algorithm, such as Apriori, is deployed to generate candidate sets of conditions (e.g., Sex=Male, 20≤Age≤30). These are combined to generate triples, with all valid triples forming the ground set V. In an example, a valid triple requires that the features in the Outer-If/Inner-If conditions do not match, and the features in the Inner-If/Then conditions match exactly with at least one change in feature value. Although Apriori is referenced herein for the frequent itemset mining algorithm, aspects of the present disclosure are not limited thereto, such that other frequent itemset mining algorithm may be utilized without limitation.

The candidate set of Outer-If conditions is referred to as subgroup descriptors (SD), while RL refers to a candidate set used to select Inner-If or Then conditions. For Apriori mining or other frequent itemset mining, the probability of an itemset in the data, or support threshold p, may determine the size of SD and RL, and consequently, the size of the ground set V. The subgroup descriptors SD may be set by the user to subgroups of interest, which is shown useful in assessing fairness via the disparate impact of recourses between subgroups. Otherwise, SD and RL may be assigned to the same set generated by Apriori. According to exemplary aspects, the GCE system or framework may deploy a non-monotone submodular maximization algorithm that selects, from the ground set V, a final, smaller set of rules R. Interpretability constraints for the total number of triples ϵ₁, the maximum width of any Outer-If/Inner-If combination ϵ₂ and the number of unique subgroup descriptors ϵ₃ in a reduced or modified set R are applied throughout. In an example, values of 20, 7, 10 were selected for ϵ₁, ϵ₂, ϵ₃, respectively.

As noted above, while the original (OG) AReS provided a novel framework, the original AReS framework falls short on two fronts, namely, (i) computational efficiency, and (ii) continuous features, which are discussed in more detail provided below along with how the GCE system or framework overcomes such shortcomings.

(i) Computational efficiency: The AReS framework requires an extremely low p value to achieve high-performance, resulting in an impractically large ground set to optimize, and resulting computational inefficiency or impracticality. Exemplary aspects of the present disclosure provides a GCE system or framework that allows for efficient generation of denser, higher-performing ground sets, unlocking utility that is lacking in the original AReS framework.

(ii) Continuous features: the original AReS framework proposes binning continuous features prior to generating frequent item sets with Apriori. However, for models trained on continuous features, this approach struggles to trade speed with performance. Too few bins result in unrealistic recourses, but too many bins result in excessive computation time for Apriori. Exemplary aspects of the present disclosure provides a GCE system or framework includes a modified ground set generation algorithm that is different from that is utilized in the original AReS framework, and demonstrates significant improvements on continuous data.

As illustrated in FIG. 4A, the GCE framework includes three general stages of processing, namely, Stage 1 (ground set generation), Stage 2 (ground set evaluation), and Stage 3 (ground set optimization).

According to exemplary aspects, SD and RL are assigned to the same set generated by Apriori. In Stage 1, SD×RL² is iterated over to compute all valid triples (Outer-If/InnerIf/Then conditions) for the ground set V. In Stage 2, each item in the ground set V is evaluated, and the optimization procedure is applied in Stage 3, returning the smaller two-level recourse set R. The three stages of processing included in the GCE framework are discussed in further detail below.

According to exemplary aspects, the GCE framework or system improves upon the original AReS framework also including 3 stages of processing, but with optimizations. In the modified AReS framework or the GCE framework, the ground set V may be defined as the set of triples from which the submodular maximization algorithm selects a two-level recourse set R⊂SD×RL². Although a prior work by Rawal & Lakkaraju (2020) indicated that the solution to be a subset R⊂SD×RL, this is mathematically impossible given that three conditions are required to form a valid triple (unless RL contains If/Then sets, which cannot be true if SD=RL, as generated by Apriori). Authors of the above noted prior work confirmed this understanding. In an example, a dataset is denoted as X, and the set of affected individuals with an unfavorable prediction from the model as X_{aff}. The objective function ƒ(R) to be maximized is positive, comprising of incorrectness, coverage and cost. The metrics used in evaluating performance are recourse accuracy (the percentage of instances in X_{aff} that are provided with a successful recourse), denoted acc(R), and average recourse cost (the average cost of those individuals in X_{aff} for whom prescribed recourses result in desired outcomes), denoted cost(R).

The overall global counterfactual search in the GCE framework for a two-level recourse set can be partitioned into three stages, as detailed in FIG. 4 and FIG. 5. Ground set Vis generated, evaluated, and optimized (e.g., by selecting a smaller, more interpretable set, R). Each of these stages are described in more detail below, alongside exemplary optimizations. According to exemplary aspects, a recourse set R may be evaluated in terms of recourse accuracy and average recourse cost, and it should be noted that, since recourse accuracy is monotonic (a new triple cannot invalidate a previous triple), |R|≤|V|=⇒acc(R)≤acc(V), provides an upper-bound.

Ground Set Generation (Stage 1)

The optimization algorithm requires a ground set V, which may be generated by iterating through SD×RL² and selecting valid triples. To generate a larger SD or RL, and thus a larger ground set V, a smaller Apriori threshold p may be utilized. With no user input, SD and RL may be automatically assigned to the same set generated by the Apriori, giving a strict subset of V⊂RL. According to exemplary aspects, one or more invalid triples may be found in the RL³. For example, if the first element of RL is “Sex=Female”, the first iteration generates the triple “If Sex=Female, If Sex=Female, Then Sex=Female”, an invalid triple. According to exemplary aspects, |RL|=n=⇒|V|<n³. Interpretability constraints that are independent of the optimization, such as ϵ₂, are applied in this stage in O(n²) and not O(n³) time.

More specifically, according to exemplary aspects, one or more constraints may be applied during the generation of the initial ground set. The GCE framework may include interpretability constraints for the total number of triples ϵ1, the maximum width of any Outer-If/Inner-If combination ϵ2 and the number of unique subgroup descriptors ϵ3 in the recourse set R. In an example, values of 20, 7, 10 are provided for ϵ1, ϵ2, ϵ3, respectively. In an example, the ϵ2 constraint for width to the ground set generation process may be expedited by constraining Apriori to only return frequent itemsets that have length ϵ2−1 or less, since those already with width ϵ2 cannot then be further combined with another itemset to form Outer-If/Inner-If conditions. If the width constraint is not violated for the If conditions, the resulting triple will automatically satisfy the constraint.

Accordingly, the constraint may be applied in the Stage 1 while the ground set is being generated (e.g., in the first two levels of the iteration through RL³). This avoids applying the width constraint mid-optimization in Stage 3, reducing the time complexity of the operation from O(n³) to O(n²). It also reduces the number of constraints used in speeding up Stage 3.

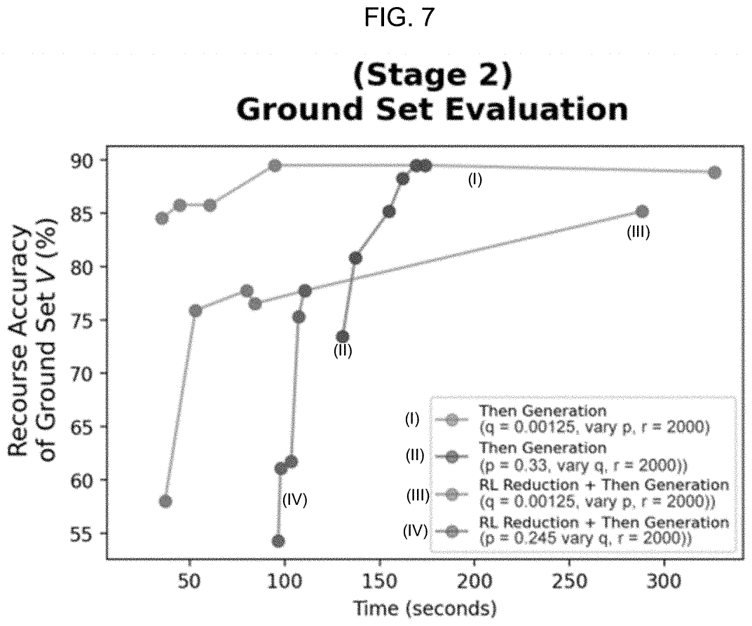

Then-Generation: A lower bound for the threshold q may be used in the Then-Generation. In fact, there always exists a lower bound when mining frequent itemsets, such as in Apriori, since no observed itemset can be observed fewer than once. Thus, setting q<1/|X| may be redundant. This allows for analysis for the full effect of 1/|X≤q≤1 in FIG. 7.

According to exemplary aspects, the GCE framework provides two methods are provided for generating the ground set V. The first method may compute a similar ground set V as provided by the AReS framework, but more efficiently. The second method may compute a different ground set V.

More specifically, the first method may perform an RL reduction process. More specifically, iterating natively over SD×RL² may be wasteful, as many members of RL will never form valid “If-Then” conditions. Accordingly, the first method instead iterate over RL in O(n) time and compute feature combinations, before removing any items that contain a feature combination that only occurs once, yielding a new RL with size an, where 0≤α≤1 (note that SD=RL is left untouched). For instance, when the item “Foreign-Worker=True, Sex=Male” has a feature combination of “Foreign-Worker, Sex” that only occurs once, it can be safely removed. For a given RL, the ground set V itself may be similar to one provided by the original AReS framework, yet (1−α²)n³ iterations may be saved, allowing for more efficient processing.

According to exemplary aspects, the second method may perform a Then-generation. More specifically, the second method, instead searching SD×RL² for triples, may search SD×RL for If conditions, and deploy a separate method to generate the Then conditions. Specifically for each valid element of SD×RL, with index i, its feature combination may be computed, and dataset may be filtered by these features (also removing inputs that satisfy the initial If conditions), before applying Apriori again, with threshold q, to generate a set of Then conditions, denoted Ti. Bound threshold q may be lowered as 1/|X| (i.e., no observed itemset can have frequency <1), and varying of the threshold q may have little impact on speed but reduces performance. (See e.g., FIG. 7). If m=max i|Ti| is the maximum size of any such Ti, the number of iterations may have an upper bound of n²m. The ground set generated may differ from the original method and significant improvements on continuous features may be observed.

Ground Set Evaluation (Stage 2)

The submodular maximization first evaluates the objective function ƒ over all triples v∈V, before initializing the solution R as the singleton set {v} with the maximum ƒ({v}). For a large |V|, this evaluation becomes computationally costly (e.g., requiring more CPU resources), more-so does the subsequent ground set optimization, and many triples may also be redundant. However, a large |V| may be required in order to find high-performing triples and achieve an acceptable upper bound on the final set, R⊆V. For example, if acc(V)=25%, acc(R)>25% may not be able to be achieved. Conversely, a ground set with acc(V)=80% may require major evaluation and will also include many low-performing, redundant triples.

Exemplary aspects of the present disclosure may take advantage of two empirical observations: (1) the generation of a large ground set V is relatively cheap computationally; and (2) the recourse accuracy acc(V) of the full ground set is approached far before the whole set has been evaluated. The noted advantages allows efficient shrinkage of the initial large ground sets to smaller ones with comparable recourse accuracy. For example, in 40 seconds, the Apriori threshold p=0.22 on the German Credit dataset produces a ground set with |V|=119708. While acc(V)=84% then takes 300 seconds to evaluate, 84% is converged to after only 5 seconds. See e.g., FIG. 5. The maximum value of a single triple is also seen to converge quickly. A large ground set may be generated, before only evaluating a small portion of this set to yield an equally high-performing yet denser ground set. Note that simply raising p to 0.323 and producing a smaller ground set of equal size does not yield 84% accuracy (instead, it yields 27%). See e.g., (A) All Selected Triples vs. (B) Maximum Single Selected Triple in FIG. 5.

According to exemplary aspects, the GCE framework may be configured to evaluate a fixed number of triples and form a new ground set in one of two ways: (i) by adding each new triple (r), or (ii) by only adding triples that increase the recourse accuracy of the new ground set (r′) (i.e., vertical steps of FIG. 5). In an example, r=None, and r′=10000 results in 10000 evaluations and less than 10000 triples added.

According to exemplary aspects, either (i) added each new triple (r), or (ii) added triples that increase the recourse accuracy of the new ground set (r′) may be utilized to reevaluate the objective function ƒ(R) over a fixed number of triples in the ground set V. In contrast, the original AReS framework evaluates the entirety of the ground set V. According to exemplary aspects, evaluation of the entire ground set is wasteful, given that performance of the first r elements of the ground set V saturates quickly, and more so if one considers that Stage 3 ground set optimization performs submodular maximization over a space potentially hundreds of times as large, as opposed to the original AReS framework that only guarantees polynomial time. The objective function ƒ(R) is discussed in further detail below with reference to the Stage 3 ground set optimization.

According to further aspects, there is a distinction between evaluating the objective function ƒ and evaluating the recourse accuracy acc and cost terms used in evaluation. In an example, no significant extra computation is required to evaluate the acc and cost terms, since the objective function ƒ returns model predictions and costs. Although the two processes differ, they may be carried out efficiently in tandem. Such observation allow termination of evaluation once saturation has been reached, and also provides an upper bound acc(R)≤acc(V). This upper bound may be reached in Stage 3 processing far before the algorithm has completed being executed, thus allowing for early termination of the algorithm and usage of processing or CPU resources. Such early termination may allow the GCE workflow to be completed/processed more efficiently or quickly with less expenditure of computing hardware resources.

Ground Set Optimization (Stage 3)

The bottleneck in the GCE framework is, however, a submodular maximization that takes the ground set V and returns a reduced set R that satisfies the interpretability constraints. The time taken is a function of the size |V| of the ground set. Accordingly, speedups may be achieved by effectively further shrinking the ground set pre-optimization. The submodular maximization may provide optimality guarantees, such that the algorithm itself is not modified. However, with knowledge of the upper bound acc(R)≤acc(V), optimization may be terminated if this bound is approached. Such a bound can also be used to determine if Stage 3 is even initiated. According to exemplary aspects, the ground set modifications of the GCE framework may provide the algorithm with a superior starting point and the upper bound instead of modifying the algorithm itself.

According to exemplary aspects, the GCE framework may be configured to sort the (new) ground set by recourse accuracy, which is already calculated, and select the s highest-performing triples. If s=r or s=r′, then no sorting occurs.

According to further aspects, there are two exemplary modifications to the Stage 3 processing of the original AReS framework that may provide improvement of performance. More specifically, the first modification is directed to the objective function, and the second modification is directed to the submodular maximization, which are discussed in further detail below.

First Modification: Objective Function

The objective function ƒ(R) is designed to be non-normal, non-negative, non-monotone and submodular, and to have constraints that are matroids. These conditions are required for the submodular maximization in the original AReS framework to have a formal guarantee of convergence. This results in four terms in ƒ(R): incorrectrecourse, cover, featurecost, and featurechange. Bar the cover term, all of these are subtracted from (i.e., maximizing correct recourse by maximizing the negative of incorrectrecourse). Such an objective function with three adjustable hyperparameters may be very difficult to tune. For that reason, an objective that consists very simply of acc(R)−λ×cost(R), which was maximized, may be utilized in the GCE framework. According to exemplary aspects, the formal guarantees of convergence (polynomial time) are largely a misdirection of efforts in the original method. Polynomial time is not particularly helpful when the size of ground sets required for certain datasets/models is huge, and thus reducing the size of the ground set while retaining quality was focused upon before the submodular maximization is applied.

Second Modification: Submodular Maximization

Algorithm executed via the GCE system states that for k constraints, up to k elements may be exchanged from the solution set R alongside the addition of one element from the ground set V. Further, the algorithm states that the optimization processing should be repeated k+1 times, before the best solution for R is then chosen. However, in reality, both of these induce high computational costs. Trivially, for the latter, ignoring the maximum width constraint and taking k+1=3, time taken by the original AReS framework may be mostly increased three-fold. According to exemplary aspects, both of these steps do not improve the performance of the AReS framework significantly and are thus omitted in the GCE system implementation.

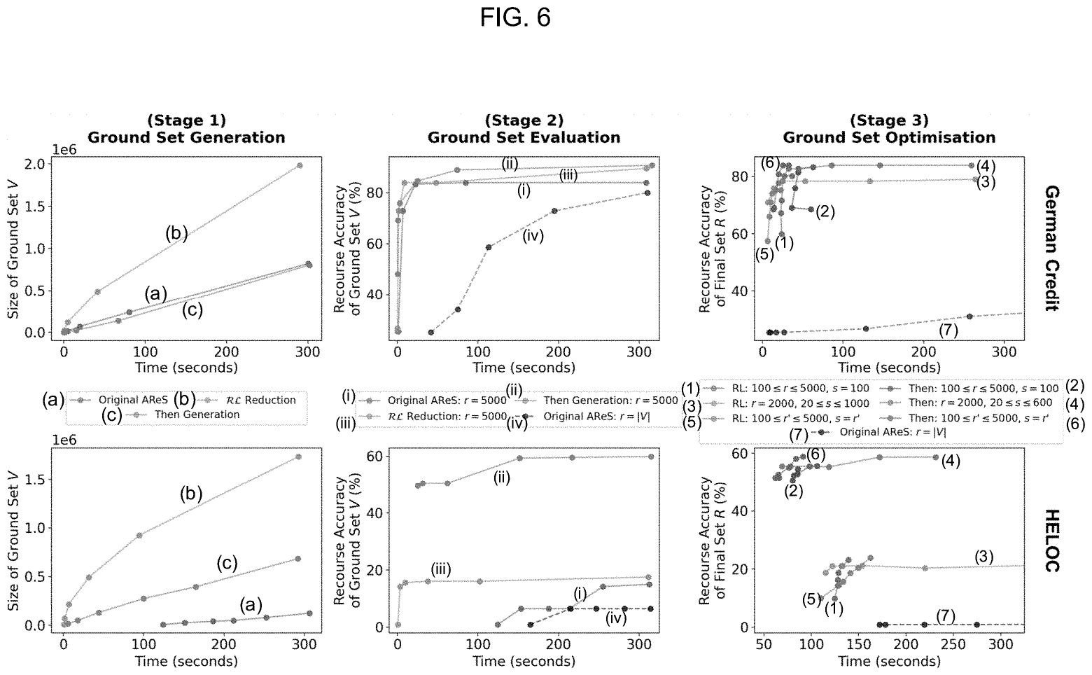

FIG. 6 illustrates a redundancy in a ground set in accordance with an exemplary embodiment.

According to exemplary aspects, the GCE framework methodology has been evaluated on two benchmarked financial datasets: (1) the German credit data set that classifies credit risk on people described by a set of attributes, consisting mostly of categorical features, and (2) the Home Equity Line of Credit (HELOC) dataset that includes anonymized credit applications made by real homeowners, and consist solely of continuous features. Deep Neural Networks (DNNs) were trained with width 50 and depth 10 and 5 respectively on these datasets, with an 80% training split. Continuous features are binned into 10 equal intervals post-training, and recourses are constructed on the training set. Layers include dropout, bias and Rectified Linear Unit (ReLU) activation functions. The final layer to the output was mapped using softmax, and Adam was utilized to optimize a cross-entropy loss function in the standard manner. The below noted table details various model parameters/behaviors.

| | | | | Train | Test | | |
|---|---|---|---|---|---|---|---|
| Name | Width | Depth | Dropout | Acc. | Acc | \|X_{aff}\| | \|X_{aff}\|/\|X\| |
| German | 50 | 10 | 0.3 | 82% | 79% | 162 | 20% |
| Credit | | | | | | | |
| HELOC | 50 | 5 | 0.5 | 74% | 73% | 3882 | 49% |

The above noted table provides a summary of the DNNs used in the experiments. The proportion of negative labels in the dataset were 30% and 53% for the German credit dataset and HELOC dataset, respectively. Exemplary models may roughly follow suit, with 20% and 49%, respectively.

Of note is the scalability of original AReS framework, which struggled with HELOC, a dataset that contained significantly more points to explain (|X_{aff}|) than the German credit dataset. Additionally, the proportion of points with positive predictions (e.g., 80% for the German credit dataset and 51% for the HELOC dataset) influences the ease with which the original AReS framework finds recourses. For stringent models (those which scarcely predict positively), it would make sense that the vast majority of frequent itemsets generated by Apriori are representative of feature value combinations that exist in the inputs with negative predictions. Accordingly, an enormous number of triples may require generation before a successful recourse may be identified.

Input dimensions of the German credit dataset were augmented by performing a one-hot encoding over necessary variables (e.g., Sex, Foreign-Worker, and the like). A cost matrix, where false positive predictions induce a higher cost than false negative predictions was ignored in the model training.

Missing values in the HELOC dataset are represented with negative integers. Inputs where all feature values are missing are dropped and replaced with the remaining missing values in the dataset with the median value of each feature. In addition, any duplicate input in the dataset may be dropped. Notably, the majority of features are monotonically increasing/decreasing.

| | | | Input | No. | No. |
|---|---|---|---|---|---|
| Name | Categorical | Continuous | Dim. | Train | Test |
| German Credit | 17 | 3 | 71* | 800 | 200 |
| HELOC | 0 | 23 | 23 | 7896* | 1975* |

*Denotes values post-processing (one-hot encoding inputs, dropping inputs).

As illustrated in FIG. 6, the top row illustrates the three stages of the GCE workflow applied for the German credit dataset, and the bottom row illustrates the three stages of the GCE workflow applied to the HELOC dataset. The left column shows a graph for Stage 1 processing with respect to size of ground set V vs. time. The center column shows a graph for Stage 2 processing with respect to the ground set acc(V) vs. time. The right column shows a graph for Stage 3 processing with respect to the final set acc(R) vs. time.

In view of FIG. 6, performance of the original AReS framework and the GCE framework are analyzed cumulatively, at each of the three stages of the workflow. For various input parameter combinations (p, r, r′ and s), the final two-level recourse sets returned in Stage 3 achieve significantly higher recourse accuracy within a time frame of 300 seconds (5 minutes), achieving accuracies for which the original AReS framework required 45 minutes on the German credit dataset, and over 18 hours on the HELOC dataset.

As illustrated in FIG. 6, in Stage 1, RL Reduction (b) is capable of generating an equivalent ground set V orders of magnitude faster than the original method (i.e., original (OG) AReS (a)). Further, in Stage 2, the GCE framework's Then Generation technique also constructs (different) ground sets rapidly. Stage 2 shrinking (r=5000) performs significantly better than full evaluation, and Then Generation erases many of the limitations surrounding continuous features. In Stage 3, vast speedups may be observed, owing to the generation of very small yet high-performing ground sets: r, r′ and s restrict the size of V yet retain a near-optimal acc(V).

As exemplified in FIG. 6, choice of SD=RL affects performance (selecting a fixed SD may reduce the size of |X_{aff}| and V). The effect of performance allows for scalability of the GCE framework that was unavailable using the original AReS framework.

Training data from each dataset may be utilized to learn recourses. Since the original AReS framework struggles to achieve sufficient recourse accuracy within reasonable timeframes for various datasets and models, hyperparameters were set for featurecost and featurechange to 0. For this setting, it was found that the average cost of recourse were low and did not vary a large amount, justifying the decision to target correctness. The remaining hyperparameters used in FIG. 6 experiments are detailed in the below table.

| | Stage 1 | Stage 2 | Stage 3 |
|---|---|---|---|
| German | OG: 0.169 ≤ p ≤ 0.390 → | OG: r = 5000 | OG: 0.39 ≤ p ≤ 0.305, r = [symbol] V [symbol] |
| Credit | RL: 0.39 ≤ p ≤ 0.149 → | RL: r = 5000 | RL: p = 0.245 |
| | Then: 0.9 ≤ p ≤ 0.30 [symbol] → | Then: r = 5000 [symbol] q = 0.00125 | Then: p = 0.48 [symbol] |
| | q = 0.00125 | OG: 0.316 ≤ p ≤ 0.26, r = [symbol] V [symbol] | q = 0.00125 |
| HELOC | OG: 0.325 ≤ p ≤ 0.285 → | OG: r = 5000 | OG: 0.324 ≤ p ≤ 0.318, r = [symbol] V [symbol] |
| | RL: 0.325 ≤ p ≤ 0.203 → | RL: r = 5000 | RL: p = 0.245 |
| | Then: 0.75 ≤ p ≤ 0.563 → | Then: r = 5000 [symbol] q = 0.000127 | Then: p = 0.48 [symbol] |
| | q = 0.000127 | OG: 0.325 ≤ p ≤ 0.3, r = [symbol] V [symbol] | q = 0.000127 |

[symbol]

indicates data missing or illegible when filed

FIG. 7 illustrates an effect of a frequent itemset mining algorithm threshold in a Then Generation method applied by a GCE system in accordance with an exemplary embodiment.

According to exemplary aspects, a range of the Apriori threshold q used in the Then Generation is bounded to a range of 1/|X|≤q≤1. FIG. 7 illustrates that for q≥1/|X|, the time taken by the algorithm has been reduced, but at the expense of a much larger drop in performance. Observe that the (II) line and (IV) lines (where p is held constant and q is varied) converge to the (I) line and (III) line (where q=1/|X| and p is varied), respectively. The (IV) line plots and (III) line plots also indicate that combining the two improvements, namely, (i) the RL Reduction and (ii) the Then Generation, perform suboptimally. Accordingly, these improvements were evaluated separately with a fixed q=1/|X| threshold used in the Then Generation method.

According to exemplary aspects, a modified AReS framework that speed up the generation of GCEs by orders of magnitude, also witnessing significant accuracy improvements on continuous data is provided.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for providing a global counterfactual explanation, the method comprising:
performing, using a processor and a memory:
generating an initial ground set based on a first candidate set of outer-If conditions (SD), and a second candidate set used for selecting Inner-If or Then conditions (RL);
evaluating a fixed number of triples and forming a new ground set that provides a recourse accuracy level above a reference threshold, wherein the fixed number of triples included in the new ground set is less than a number of triples included in the initial ground set;
sorting the new ground set by recourse accuracy;
selecting a predetermined number of triples based on corresponding recourse accuracies indicated in the sorting; and
performing calculation based on the selected number of triples.

2. The method according to claim 1, wherein the generating of the ground set is performed by iterating over the second candidate set in O(n) time and computing feature combinations, before removing any items that contain a feature combination that only occurs once, for yielding a new RL with size an, and
wherein α is greater than or equal to 0 and less than or equal 1.

3. The method according to claim 1, wherein the generating of the ground set is performed by filtering a dataset based on the outer-If or the inner-If conditions, and separately deploying a method for generating Then conditions.

4. The method according to claim 1, wherein each triple includes an outer-If condition, an inner-If condition, and a Then condition.

5. The method according to claim 1, wherein the selecting of the predetermined number of triples includes selecting highest-performing triples within the new ground set.

6. The method according to claim 1, wherein each triple forming the new ground set increases the recourse accuracy level.

7. The method according to claim 1, wherein one or more constraints are applied during the generating of the initial ground set.

8. The method according to claim 1, wherein the initial ground set removes a feature combination that only occurs once.

9. The method according to claim 1, wherein an upper bound defined as acc(R)≤acc(V) is reached before an algorithm for providing the global counterfactual explanation has completed execution,
wherein acc(R) is a percentage of instances in X_{aff} that are provided with a successful recourse,
wherein X_{aff} is a set of individuals with an unfavorable prediction from a model, and
wherein acc(v) is a recourse accuracy.

10. The method according to claim 9, wherein the algorithm is terminated prior to its completion when the upper bound for saturation is reached.

11. A system for providing a global counterfactual explanation, the system comprising:
at least one processor;
at least one memory; and
at least one communication circuit,
wherein the at least one processor performs:
generating an initial ground set based on a first candidate set of outer-If conditions (SD), and a second candidate set used for selecting Inner-If or Then conditions (RL);
evaluating a fixed number of triples and forming a new ground set that provides a recourse accuracy level above a reference threshold, wherein the fixed number of triples included in the new ground set is less than a number of triples included in the initial ground set;
sorting the new ground set by recourse accuracy;
selecting a predetermined number of triples based on corresponding recourse accuracies indicated in the sorting; and
performing calculation based on the selected number of triples.

12. The system according to claim 11, wherein the generating of the ground set is performed by iterating over the second candidate set in O(n) time and computing feature combinations, before removing any items that contain a feature combination that only occurs once, for yielding a new RL with size an, and
wherein α is greater than or equal to 0 and less than or equal 1.

13. The system according to claim 11, wherein the generating of the ground set is performed by filtering a dataset based on the outer-If or the inner-If conditions, and separately deploying a method for generating Then conditions.

14. The system according to claim 11, wherein each triple includes an outer-If condition, an inner-If condition, and a Then condition.

15. The system according to claim 11, wherein the selecting of the predetermined number of triples includes selecting highest-performing triples within the new ground set.

16. The system according to claim 11, wherein each triple forming the new ground set increases the recourse accuracy level.

17. The system according to claim 11, wherein one or more constraints are applied during the generating of the initial ground set.

18. The system according to claim 11, wherein the initial ground set removes a feature combination that only occurs once.

19. The system according to claim 11, wherein an upper bound defined as acc(R)≤acc(V) is reached before an algorithm for providing the global counterfactual explanation has completed execution,
wherein acc(R) is a percentage of instances in X_{aff} that are provided with a successful recourse,
wherein X_{aff} is a set of individuals with an unfavorable prediction from a model, and
wherein acc(v) is a recourse accuracy.

20. The system according to claim 19, wherein the algorithm is terminated prior to its completion when the upper bound for saturation is reached.
